(19) United States
(12) Patent Application Publication
(10) Pub. No.: US 2005/0069762 A1
(43) Pub. Date: Mar. 31, 2005

(54) Battery container

(75) Inventors: James T. Daley, Cedarburg, WI (US); David J. Gondek, Chicago, IL (US); Michael J. Keagle, Richfield, WI (US); Dale B. Trester, Milwaukee, WI (US); Mark S. Inkmann, Wauwatosa, WI (US); Glenn W. Andersen, Hartford, WI (US)

Correspondence Address: Marcus W. Sprow;Foley & Lardner LLP, 777 East Wisconsin Avenue, Milwaukee, WI, 53202-5306, US

(73) Assignee: Johnson Controls Technology Company

(21) Appl. No.: 10/833,881

(22) Filed: Apr. 28, 2004

Related U.S. Application Data
(60) Provisional application No. 60/466,098, filed on Apr. 28, 2003.

(51) Int. Cl. H01M 2/08; H01M 2/02

(52) U.S. Cl. 429/179; 429/180; 429/181

(57) ABSTRACT

A container for a battery includes a top portion having a generally rectangular shape and that is configured for coupling to a cover for the battery. The container also includes a plurality of cell containers extending from the top portion for housing wound cells elements. The cell containers have a generally cylindrical shape and are arranged in an offset configuration. The container also includes a structure extending from the top portion in an area of the top portion not supported by a cell container due to the offset cell container configuration. The structure provides enhanced structural rigidity for the top portion in the area of the top portion not supported by a cell container.

### CROSS-REFERENCE TO RELATED APPLICATIONS

This application claims the benefit under 35 U.S.C. § 119(e) of U.S. Provisional Application No. 60/466,098, filed Apr. 28, 2003. The entire disclosure of U.S. Provisional Application No. 60/466,098 is expressly incorporated herein by reference.

### FIELD

The present invention relates generally to the field of batteries (e.g., lead-acid batteries for use as automotive, marine, commercial, and industrial batteries, for use in starting, lighting, and ignition (SLI) and other applications). More specifically, the present inventions relate to containers or housings that include structural supports for batteries having an offset cell design.

### BACKGROUND

Batteries (e.g., lead-acid batteries for use in vehicle starting, lighting, and ignition, applications, commercial batteries, industrial batteries, marine batteries, etc.) include containers or housings that generally include a number of individual cell containers that are configured to provide containment for battery cell elements, which generally comprise one or more positive electrodes, one or more negative electrodes, a relatively porous separator between adjacent electrodes, and an electrolyte or acid (e.g., sulfuric acid). For example, a 12 Volt vehicle battery may include six individual cell containers.

During manufacturing of batteries, a battery cover is conventionally attached to a battery container by heat sealing or other means. During such operations, a downward pressure or force is applied to the cover and container to ensure that an adequate seal is provided between the cover and container.

Battery cell elements may be provided in a wound configuration (e.g., spiral wound) such that a single positive electrode and a single negative electrode separated by a relatively porous polymeric separator are wound in a spiral such that the electrodes and separator have a generally cylindrical shape. Accordingly, the cell containers for containing such spiral wound cell elements is also provided in a relatively cylindrical configuration.

For certain applications, it may be desirable to provide a battery container that has individual cell containers (e.g., parallel rows of cell containers) arranged in an offset or staggered configuration. One example of such a configuration is shown in U.S. Pat. No. 5,599,641 titled “Battery Terminal and Case Structure,” issued Feb. 4, 1997. Such containers may include a top portion that overhangs or is provided over an area that is unsupported by cell containers due to the offset configuration of the cell containers. As shown in U.S. Pat. No. 5,599,641, such area may be utilized as a location for a battery terminal for connecting the battery to components of a vehicle electrical system.

It would be desirable to provide a battery container or housing that includes cell containers arranged in an offset or staggered configuration. It would also be desirable to provide a battery container that includes offset cell containers and that resists deformation during manufacturing, transport, and storage of the battery. It would also be desirable to provide a battery container that includes offset cell containers and that has at least a portion that is unsupported by cell containers and which resists has sufficient structural integrity to resist damage during manufacturing and transport of the battery. It would be desirable to provide a battery container and battery having one or more of these or other advantageous features.

### SUMMARY

The present invention relates to a container for a battery. The container includes a top portion having a generally rectangular shape. The top portion is configured for coupling to a cover for the battery. The container also includes a plurality of cell containers extending from the top portion for housing wound cells elements. The cell containers have a generally cylindrical shape and are arranged in an offset configuration. The container also includes a structure extending from the top portion in an area of the top portion not supported by a cell container due to the offset cell container configuration. The structure provides enhanced structural rigidity for the top portion in the area of the top portion not supported by a cell container.

The present invention also relates to a container for a battery having a plurality of cell containers arranged in an offset configuration. The cell containers are configured for housing wound cell elements. The container includes a top portion coupled to the plurality of cell containers and configured for coupling to a cover for the battery. A portion of the top portion extends away from the cell containers and is unsupported by one of the plurality of cell containers. The container also includes a base and a member extending between the top portion and the base to support the portion of the top portion that is unsupported by one of the plurality of cell containers.

The present invention also relates to a battery having a container that includes a plurality of cell containers having generally cylindrical shapes and that are arranged in an offset configuration. The cell containers configured for housing wound cell elements. The container includes a top portion coupled to the plurality of cell containers and to a cover for the battery. A portion of the top portion is unsupported by one of the plurality of cell containers due to the offset arrangement of the cell containers. The container also includes a structure for supporting the portion of the top portion that is not supported by one of the plurality of cell containers. The structure extends between the top portion and at least one of a cell container and a base of the container.

### BRIEF DESCRIPTION OF THE DRAWINGS

FIG. 1 is a perspective view of a battery having a container or housing according to an exemplary embodiment.

FIG. 2 is another perspective view of the battery shown in FIG. 1.

FIG. 3 is a perspective view of the container used in the battery shown in FIG. 1.

FIG. 4 is a bottom view of the container shown in FIG. 3.

FIG. 5 is a perspective view of a container or housing according to another exemplary embodiment.

FIG. 6 is another perspective view of the container or housing shown in FIG. 5.

FIG. 7 is a side view of the container or housing shown in FIG. 5.

FIG. 8 is a perspective view of a handle for use with a battery such as that shown in FIG. 1.

FIGS. 9-12 illustrate a handle such as that shown in FIG. 8 being provided in a slot formed in a container or housing of a battery such as that shown in FIG. 1.

### DETAILED DESCRIPTION OF EXEMPLARY EMBODIMENTS

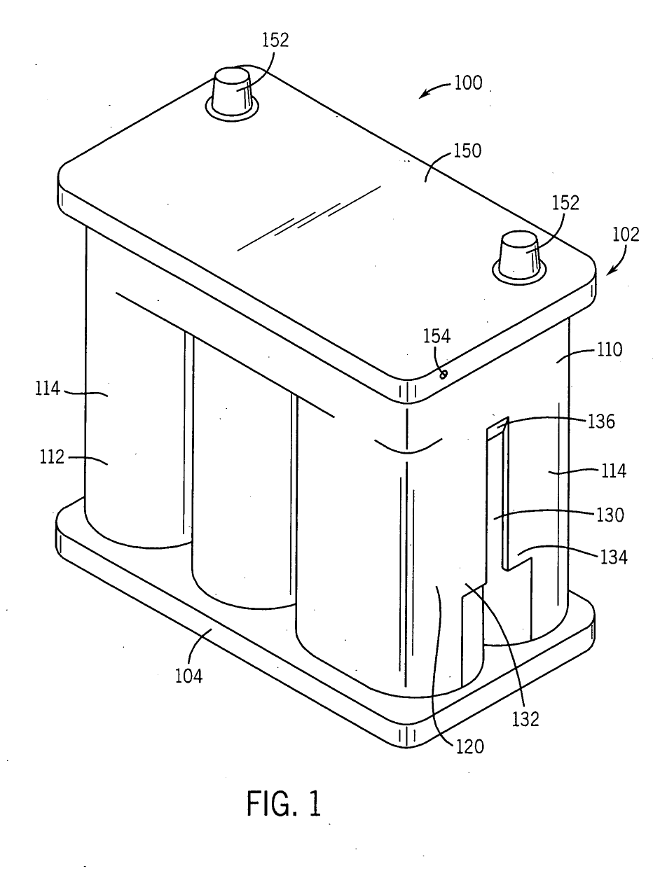

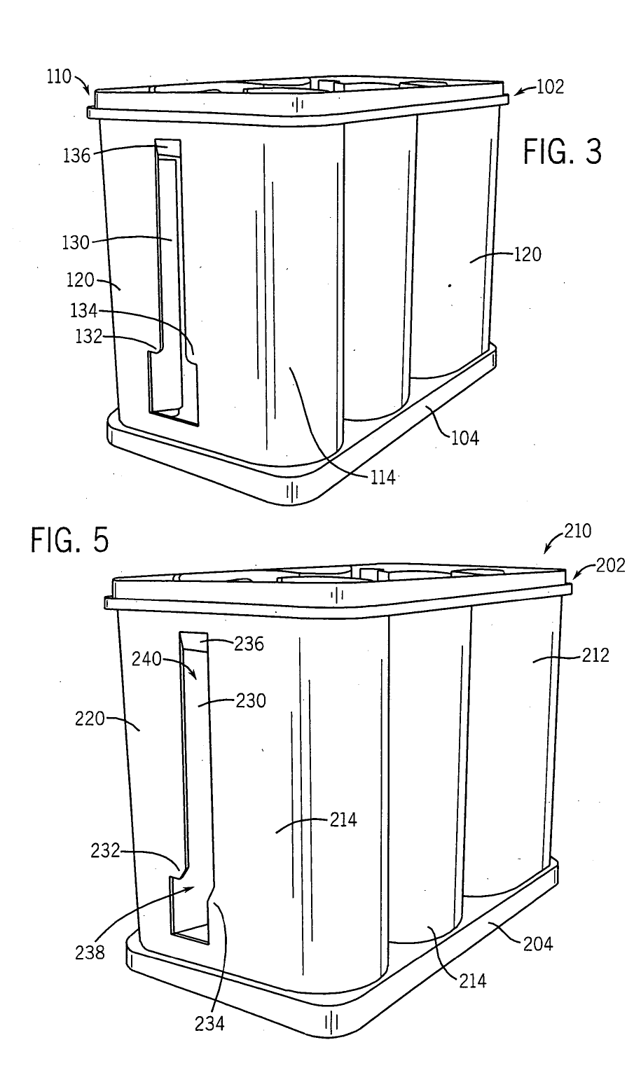

According to an exemplary embodiment, a battery 100 includes a container or housing 110 and a cover 150 (see, e.g., FIGS. 1-4) that is coupled to a top portion 102 of the container (e.g., by heat sealing, adhesive, etc.). Positive and negative terminals or posts 152 extend from a top surface of cover 150 according to an exemplary embodiment, although according to other exemplary embodiments, the terminals may extend from a side of the battery. One or more vents 154 may also be provided to allow the expulsion of gases from the interior of battery 100.

Container 110 includes a plurality of cell containers or housings 112 defined by one or more walls 114. While the FIGURES illustrate a container having six cell containers, a different number of cell containers (e.g., 3, 5, 12, 18, or any other number) may be provided according to other exemplary embodiments. Walls 114 extend between top portion 102 of container 110 and a base or platform 104 of container 110. According to an exemplary embodiment, base 104 is integrally formed with at least a portion of a plurality of cell walls 114. According to another exemplary embodiment, base 104 is produced separately and coupled to the cell walls.

Each of cell containers 112 is configured to contain therein a cell element (not shown) of the battery. The cell element may be a wound cell element that includes a positive electrode, a negative electrode, and a separator such as an absorptive glass mat (AGM) separator provided between the positive and negative electrode. The electrodes and the separator are wound or wrapped in a spiral, and acid (e.g., sulfuric acid) may be provided in the cell container.

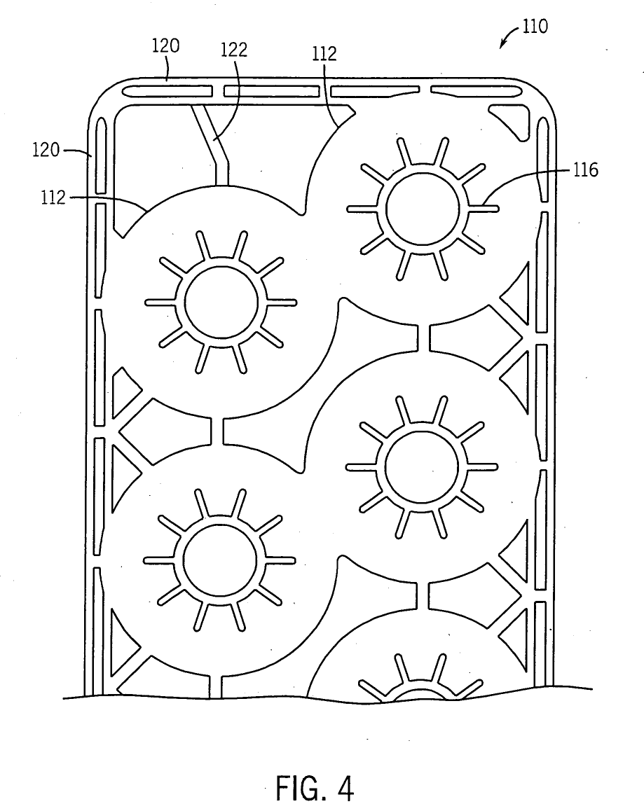

According to an exemplary embodiment, cell containers 112 have a generally cylindrical configuration. According to other exemplary embodiments, cell containers 112 may have other configurations (e.g., a “tapered” shape having a different diameter at one of the top or bottom of the cell container, an “hourglass” shape, etc.). The cell containers 112 may also have features formed on the bottom thereof (e.g., ribs or protrusions 116 as shown in FIG. 4).

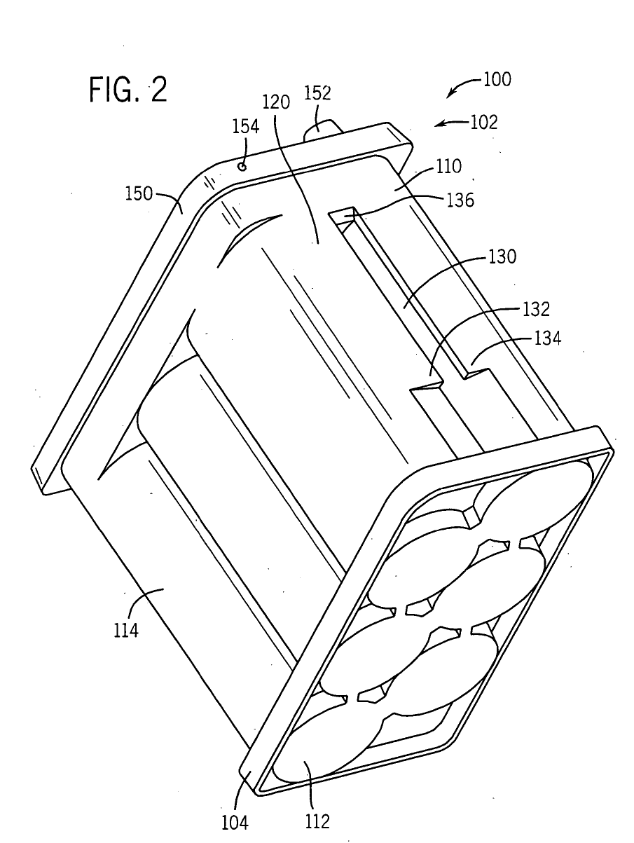

Cell containers 112 are arranged in an offset or staggered pattern (see, e.g., FIG. 2). In conventional batteries having such an offset cell container arrangement, two corners of the battery container diagonally opposite one another are unsupported by a wall of a cell container (e.g., there is no structural member between the top portion and base of the container at these corners). This may result in buckling, warping, bending, or other deformation of the cover and/or container during storage, shipping, and/or during the attachment of the cover to the container in heat sealing or other operations.

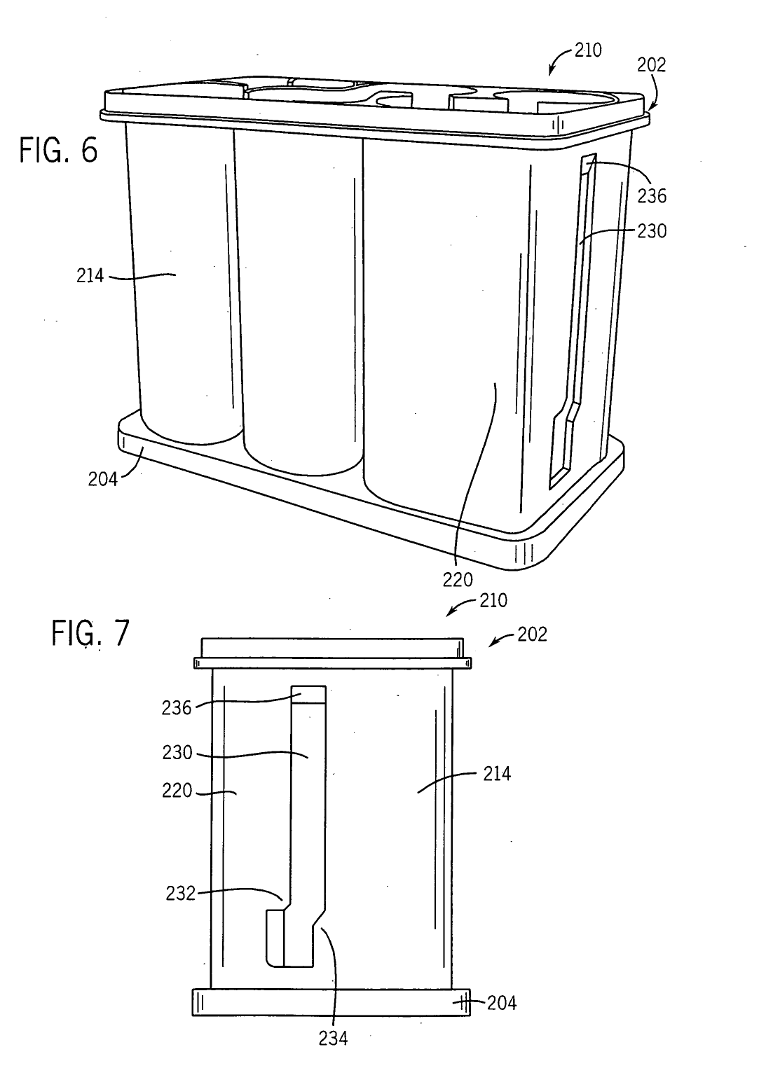

According to an exemplary embodiment, a support or structure such as a structural member 120 (see, e.g., FIGS. 1 and 6) is provided that extends between top portion 102 and base 104 of container 110 in each of the two opposite corners that would otherwise be unsupported in the absence of such a support. Support 120 is provided adjacent to and in contact with one or more cell walls 114 (see, e.g., FIG. 4, showing a support adjacent and coupled to two cell walls of the battery container, such that the support forms an “extension” of the cell walls).

According to an exemplary embodiment, two supports 120 are provided in container 110, with each support being provided at opposite corners of container 110. According to other exemplary embodiments, a different number or configuration of supports may be provided.

The size, shape, and configuration of support 120 may vary according to various embodiments. According to a preferred embodiment, support 120 is provided in the form of a “false wall” that is integrally formed with and adjacent to one or more of cell walls 114 to form a panel for container 110. Support 120 may also be integrally formed with top portion 102 and/or base 104 of the container. According to another exemplary embodiment, the support may be produced separately (e.g., in a separate molding process) and coupled to the container to provide a support between the top portion and the base).

Support 120 is intended to provide a relatively rigid reinforcing structural member that may provide added support for top portion 102 and cover 150 during attachment of cover 150 to container 110 (e.g., in a heat sealing operation, etc.). Support 120 may also provide increased strength for container 110 to reduce or eliminate damage to container 110 and/or cover 150 during storage and/or use (e.g., when batteries are stacked on pallets during shipping/storage). Support 120 may also provide a pleasing aesthetic appearance to the container (e.g., it may partially or totally conceal the offset cell design of the container by providing a relatively uniform exterior surface).

According to various other exemplary embodiments, the support may have other configurations. For example, the support may be provided in the form of a bar or rod that extends between the top portion and the base of the container to provide support for the top portion and/or cover. According to another exemplary embodiment, the support may extend between the top portion and a cell wall (e.g., not between the top portion and the base). Various other configurations may also be used according to various other exemplary embodiments.

According to an exemplary embodiment, support 120 is integrally formed with one or more cell walls 114, top portion 102 of container 110, and base 104 of container 110 to form a portion of a panel for container 110. According to another exemplary embodiment, the support is produced separately and coupled to the container.

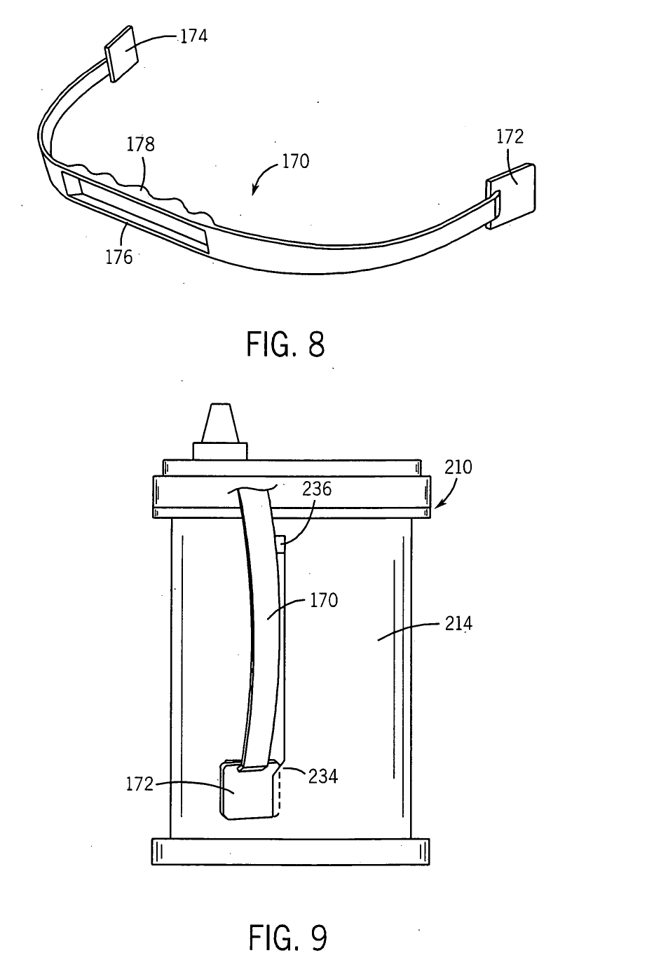

An empty space or recess is provided between cell wall 114 and support 120 (see, e.g., FIG. 5). A rib or support 122 (e.g., a floating rib) may be provided in a space formed between the support and one or more of the cell walls (see, e.g., FIG. 4). It is intended that rib 122 provides enhanced structural rigidity for container 110 and/or provides a guide for a handle (e.g., handle 170 shown in FIG. 8) inserted into the space. According to an exemplary embodiment, rib 122 extends the entire distance between top portion 102 and base 104 of container 210. According to another exemplary embodiment, the rib may extend only partially along such distance.

One or more slots or apertures 130 are formed in container 110 to receive a portion of a battery handle 170 (see, e.g., FIG. 8) therein. According to an exemplary embodiment, slots 130 are formed at the shorter ends of container 110, and are at least partially defined by a portion of support 120 and a cell wall 114 and/or one or more extensions (e.g., webs, tabs, flaps, or flanges) extending from one or both of the support and cell wall.

According to an exemplary embodiment, slots 130 are configured to receive at least a portion of a handle therein. Slots 130 have a size and shape configured to provide relatively secure attachment of a handle (e.g., handle 170) to the container (e.g., slots 130 may allow sliding engagement with an end portion of a battery handle as described below).

The slots may be provided in any of a variety of configurations. FIGS. 1-4 show one exemplary embodiment of such a slot (slot 130), in which an extension 132 (e.g., a web or flap) is formed that extends from support 120 and another extension 134 extends from a cell wall 114. Together, extensions 132 and 134 act to define the slot or opening 130 in the side of container 110. According to an exemplary embodiment, slot 130 tapers from a wider to a narrower dimension moving from base 104 toward top portion 102 of container 110. Thus, slot 130 shown in FIG. 1 forms a tapered aperture or opening in the end panel of container 110. According to other exemplary embodiments, slot 130 may not include a taper, such that the width of the slot is relatively constant between the uppermost and lowermost portion of the slot.

The size and/or shape of the slot formed between the support and the cell wall may vary according to alternative embodiments. FIGS. 5-7 show a battery container or housing 210 similar to that shown in FIGS. 1-4 and having a top portion 202, a base 204, and a slot 230 according to another exemplary embodiment. Slot 230 has a different configuration that slot 130 shown in FIGS. 1-4. Slot 230 includes an extension 232 extending from a support 220 and another extension 234 extending from a cell wall 214. However, extensions 232 and 234 are arranged such that a bottom portion 238 (e.g., an opening) of the slot is offset from an upper portion 240 of slot 230. Bottom portion 238 also has a wider dimension than upper portion 240. Such a configuration is intended to allow insertion of a portion of a handle in lower portion 238 of slot 230, and movement of the portion of the handle upward in the offset upper portion 240 to secure the handle in slot 230. Extensions 232 and 234 define the offset configuration and provide a transition between bottom portion 238 and the relatively linear (e.g., non-tapered) upper portion 240 of the slot. According to another exemplary embodiment, the upper portion of the slot may have a tapered configuration such that it narrows from bottom of the upper portion to the top of the upper portion.

A top portion of slots 130 and 230 includes a feature 136 or 236, respectively, that is tapered or angled to provide a surface that will abut a portion of a handle when the handle is inserted in the slot. For example, the feature 136 or 236 provides a transition from the slot to the outer surface of the container to reduce frictional damage to the handle.

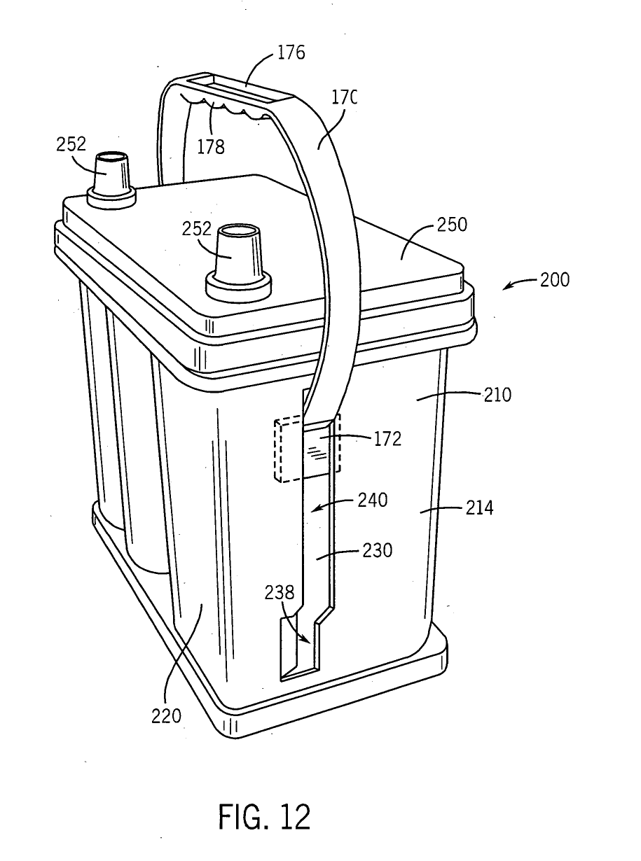

FIGS. 9-12 illustrate the insertion of a handle 170 (see, e.g., FIG. 8) into slot 232 formed in container 210 of a battery 200 having a cover 250 and terminals 252 as shown in FIG. 12. A first end portion 172 of handle 170 is inserted in a first slot 230 formed in container 210, after which the a second end portion 174 of the handle is inserted in a second slot (not shown) formed in container 210 on the side of container 210 opposite the first slot 230.

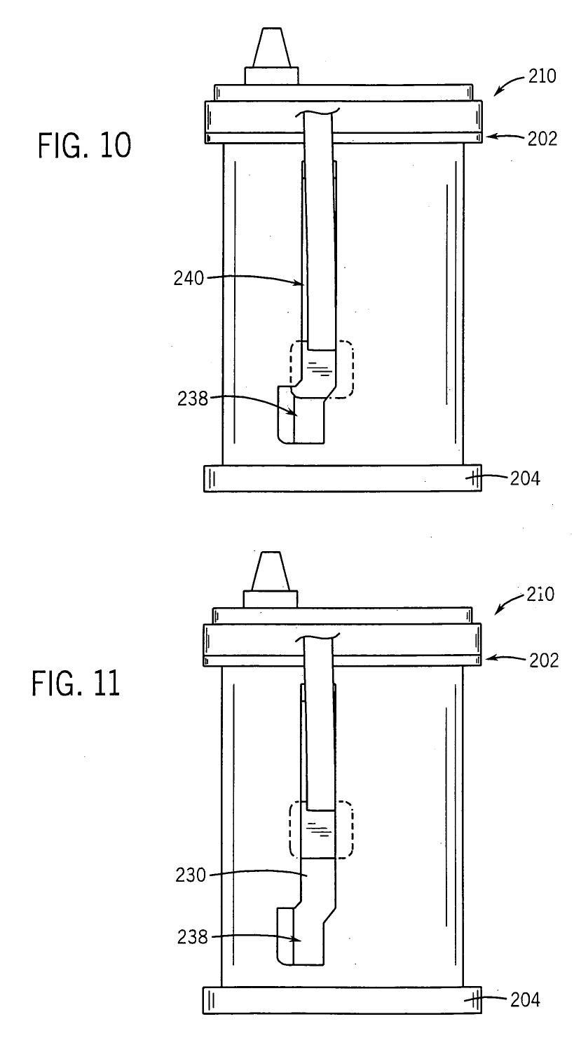

The first end portion 172 of handle 170 is inserted into the wider bottom portion 238 of slot 230 (FIG. 9). After insertion of the first end portion 172 of handle 170 into slot 230, first end portion 172 is moved upward in slot 230 (FIGS. 10-11) along a path formed by upper portion 240 of slot 230 (e.g., away from base 204 and toward top portion 202 of container 210). Second end portion 174 of handle 170 may then be inserted into the wider portion of the second slot on the opposite side of container 210. Second end portion 174 of handle 170 is then moved upward in the second slot. As the end portions 172, 174 are moved upward in their respective slots, the end portions may be directed by “floating ribs” (as shown in FIG. 4 as rib 122) to a narrower portion of the slots.

According to an exemplary embodiment, the size and shape of handle 170 is such that removal of handle 170 from container 210 may be relatively difficult to reduce and/or prevent the occurrence of accidental removal of handle 170. For example, the length of 170 handle may be such that both ends of the handle may not be removed simultaneously—instead, the reverse of the process described above must be followed, in which one of the ends is removed first, after which the second may be removed by proper positioning of the handle. That is, one handle end portion would have to be positioned toward the top of its associated slot to remove the opposite handle end portion from the bottom portion of its slot.

With a portion of the handle received in each of the two slots formed in the container, a center portion 176 of handle 170 having a gripping surface 178 may be grasped to lift or move the battery (see, e.g., FIG. 12, with handle 170 arranged in the “carrying” position). Center portion 176 of the handle may also be arranged adjacent battery cover 250 when battery 200 is in storage to allow stacking of other batteries above battery 200. In this arrangement, end portions 172, 174 of handle 170 may slide downward in their respective slots toward base 204 of container 210. The size and shape of handle 170 is such that the end portions 172, 174 of handle 170 will not slide out of the slots in the storage position.

The container or housing may be made of any polymeric material (e.g., polyethylene, polypropylene, etc.) suitable for use as a battery container. Such polymeric material is relatively resistant to degradation caused by acid (e.g., sulfuric acid) provided within cells of the container. For example, the container may be made of a polypropylene-containing material (e.g., pure polypropylene, copolymers comprising polypropylene, polypropylene with additives, etc.).

According to an exemplary embodiment, the one or more supports are made from the same material as the remainder of the container. Such supports may be integrally formed (e.g., molded) with the container such that the supports and container are produced in a single manufacturing operation. According to an alternative embodiment, the supports may be made from a different material than the rest of the container (e.g., from a different polymeric material, from a metal, or from another material). According to another alternative embodiment, the support may be installed on the container after the container is produced (e.g., by adhering or otherwise coupling a support to the container).

The size, shape, and configuration of the one or more supports may vary in alternative embodiments. The supports are configured to provide a relatively rigid structural support which extends between a top portion and a base of a container. Such supports may be provided at opposite corners of the container in an area that would otherwise be unsupported due to an offset configuration of the cell walls provided in the container. According to an exemplary embodiment, the space between the supports and the cell walls may be configured to receive therein a portion of a handle (e.g., a slot may be formed that defines an opening into which a portion of a handle may be inserted). The opening may be defined by the support and the cell walls and also may be at least partially defined by extensions which are formed on or coupled to the support and/or one or more cell walls.

According to an alternative embodiment, all or part of the space between the support and the cell walls may be used to store excess acid for the battery, electronic components, or other items that may be provided for a battery (e.g., a fluid reservoir may be provided in the space).

It will be appreciated by those of skill in the art reviewing this disclosure that a variety of advantageous features may be obtained using a container such as that disclosed in the exemplary embodiments of the present disclosure. For example, such a container may provide enhanced structural support for the container during attachment of a cover to the battery container (e.g., to prevent bowing or warpage of the cover and/or container during attachment) and during storage and/or use of the battery. Such a container may also act to improve manufacturability of batteries having offset cell configurations. Further, such a container may provide enhanced aesthetic appeal, for example, by concealing the offset arrangement of the cells containers.

It is important to note that the construction and arrangement of the elements of the container or housing as shown in the exemplary embodiments is illustrative only. Although only a few embodiments of the present inventions have been described in detail in this disclosure, those skilled in the art who review this disclosure will readily appreciate that many modifications are possible (e.g., variations in sizes, dimensions, structures, shapes and proportions of the various elements, mounting arrangements, use of materials, colors, orientations, etc.) without materially departing from the novel teachings and advantages of the subject matter recited herein. For example, elements shown as integrally formed may be constructed of multiple parts or elements (e.g., instead of providing integrally formed supports for the battery container, the supports may be created separately (e.g., by molding) and coupled to the battery container), the position of elements may be reversed or otherwise varied (e.g., size and/or shape of the slots may vary), and the nature or number of discrete elements or positions may be altered or varied (e.g., instead of having two supports, only a single support may be provided; instead of having six cell containers, the battery container may include a different number of cell containers). It should be noted that the elements and/or assemblies of the system may be constructed from any of a wide variety of materials that provide sufficient strength or durability, including any of a wide variety of moldable plastic materials (such as high-impact plastic) in any of a wide variety of colors, textures and combinations. Other substitutions, modifications, changes and omissions may be made in the design, operating conditions and arrangement of the preferred and other exemplary embodiments without departing from the scope of the present inventions.

1. A container for a battery comprising:
a top portion having a generally rectangular shape, the top portion configured for coupling to a cover for the battery;
a plurality of cell containers extending from the top portion for housing wound cells elements, the cell containers having a generally cylindrical shape and being arranged in an offset configuration; and
a structure extending from the top portion in an area of the top portion not supported by a cell container due to the offset cell container configuration;
wherein the structure provides enhanced structural rigidity for the top portion in the area of the top portion not supported by a cell container.

2. The container of claim 1 further comprising a base coupled to the plurality of cell containers, wherein the cell containers extend between the top portion and the base.

3. The container of claim 2 wherein the structure extends between the top portion and the base.

4. The container of claim 3 wherein the structure is separated by a distance from the cell containers such that the structure defines an open space between the cell containers and the structure.

5. The container of claim 1 wherein the structure extends between the top portion and at least a portion of a cell container.

6. The container of claim 1 wherein the structure is integrally formed with at least one cell container such that the structure is provided as an extension of the cell container.

7. The container of claim 1 further comprising an extension that extends from a cell container, wherein the structure and the extension define a slot in the container into which a portion of a handle for the battery may be inserted.

8. The container of claim 7 wherein the slot includes a top portion and a bottom portion, and wherein the bottom portion of the slot is wider than the top portion of the slot.

9. The container of claim 8 wherein the width of the slot tapers from a first width to a second width, the second width being greater than the second width.

10. The container of claim 8 wherein the top portion of the slot is offset from the bottom portion of the slot.

11. The container of claim 1 further comprising a member extending between the structure and at least one of the plurality of cell containers.

12. A container for a battery having a plurality of cell containers arranged in an offset configuration, the cell containers configured for housing wound cell elements, the container comprising:
a top portion coupled to the plurality of cell containers and configured for coupling to a cover for the battery, wherein a portion of the top portion extends away from the cell containers and is unsupported by one of the plurality of cell containers;
a base; and
a member extending between the top portion and the base to support the portion of the top portion that is unsupported by one of the plurality of cell containers.

13. The container of claim 12 wherein the member is separated from the cell containers by a distance such that the member defines an open space between the cell containers and the member.

14. The container of claim 13 wherein the member defines at least a portion of a slot configured for allowing the insertion of a portion of a handle for the battery into the open space.

15. The container of claim 14 wherein the slot includes a top portion and a bottom portion, and the bottom portion of the slot is wider than the top portion of the slot.

16. The container of claim 15 wherein the bottom portion of the slot is offset from the top portion of the slot.

17. The container of claim 14 further comprising an extension coupled to one of the plurality of cell containers, the extension also defining at least a portion of the slot.

18. The container of claim 12 wherein the member is coupled to at least a portion of one of the plurality of cell containers.

19. The container of claim 18 wherein the member is integrally formed with at least one of the plurality of cell containers.

20. The container of claim 12 wherein the container includes at least two members extending between the top portion and the base to support portions of the top portion that are unsupported by one of the plurality of cell containers.

21. A battery having a container that includes a plurality of cell containers having generally cylindrical shapes and arranged in an offset configuration, the cell containers configured for housing wound cell elements, the container comprising:
a top portion coupled to the plurality of cell containers and to a cover for the battery, wherein a portion of the top portion is unsupported by one of the plurality of cell containers due to the offset arrangement of the cell containers; and
a structure for supporting the portion of the top portion that is not supported by one of the plurality of cell containers, the structure extending between the top portion and at least one of a cell container and a base of the container.

22. The battery of claim 21 further comprising a base coupled to at least one of the cell containers, wherein the structure extends between the top portion and the base.

23. The battery of claim 22 wherein the structure is integrally formed with the top portion and the base.

24. The battery of claim 23 wherein the structure is integrally formed with at least one of the plurality of cell containers.

25. The battery of claim 21 further comprising an extension that extends from at least one of the cell containers, and wherein the structure and the extension define at least a portion of a slot provided in the container.

26. The battery of claim 25 further comprising a handle, at least a portion of the handle being provided within the slot.

27. The battery of claim 26 further a second slot provided in the battery, wherein a second portion of the handle is provided within the second slot.

28. The battery of claim 25 wherein the slot has a bottom portion and a top portion, and wherein the top portion is narrower than the bottom portion.

29. The battery of claim 28 wherein the bottom portion of the slot is offset from the top portion of the slot.

30. The container of claim 28 wherein the top portion of the slot tapers from a first width to a second width, the second width being narrower than the first width.
